(19) United States
(12) Patent Application Publication
(10) Pub. No.: US 2026/0198725 A1
(43) Pub. Date: Jul. 16, 2026

(54) POURING STRUCTURE OF BEVERAGE MAKING MACHINE

(71) Applicant: Foshan WinLin Smart Technology Co., Ltd, Foshan (CN)

(72) Inventors: Jingdan XU, Foshan (CN); Huiling ZENG, Foshan (CN)

(73) Assignee: Foshan WinLin Smart Technology Co., Ltd, Foshan (CN)

(21) Appl. No.: 19/026,691

(22) Filed: Jan. 17, 2025

(30) Foreign Application Priority Data
Jan. 13, 2025 (CN) 202520076213.6

(51) Int. Cl. A47J 31/46; A47J 31/44

(52) U.S. Cl. CPC A47J 31/46; A47J 31/4403

(57) ABSTRACT

The present invention relates to the technical field of a beverage making machine, and discloses a pouring structure of a beverage making machine with a good drainage effect. The pouring structure (30) is set to an open structure (30a), and a surface (320a) of the pouring structure (30) is radially inclined relative to a central axis of a mixing container (20). Opposite edges (320c) of the pouring structure (30) are set with a slope relative to the surface (320a), and a plurality of orifices (320g) communicating with an inner cavity of the mixing container (20) is provided on one end surface (320b) of the pouring structure (30).

### RELATED APPLICATIONS

The present patent document claims the benefit of priority to Patent Application No. 202520076213.6, filed January 13, 2025, and entitled “POURING STRUCTURE OF BEVERAGE MAKING MACHINE,” the entire contents of each of which are incorporated herein by reference.

### BACKGROUND

### 1 Technical Field

The present invention relates to the technical field of a beverage making machine, and in particular to a pouring structure of a beverage making machine.

### 2 Background Information

At least one open structure is formed at the top of an existing mixing container for pouring fluid into the mixing container, and liquid ingredients can be poured into an inner cavity of the mixing container through the open structure. When the fluid is poured, a substance (such as snowflakes/shaved ice) to be mixed in the mixing container may splash or overflow to the outside by instantaneous inflow fluid impact, resulting in liquid loss due to splashing or ingredient expansion generated by an impact force.

### BRIEF SUMMARY

The present invention provides a pouring structure of a beverage making machine with a good drainage effect to resolve a technical problem that a substance (such as snowflakes/shaved ice) to be mixed in a mixing container may splash or overflow to the outside by instantaneous inflow fluid impact when fluid is poured.

Technical solutions used in the present invention to resolve the technical problem are as follows: a pouring structure of a beverage making machine is provided and configured for the beverage making machine.

The pouring structure is configured in a mixing container and matched at an upper end of the mixing container along a central axis of the mixing container,

the pouring structure is set to an open structure, and a surface of the pouring structure is radially inclined relative to the central axis of the mixing container;

opposite edges of the pouring structure are set with a slope relative to the surface,

and a plurality of orifices communicating with an inner cavity of the mixing container is disposed on one end surface of the pouring structure.

In some implementations, the opposite edges are radially inclined to guide poured liquid into the mixing container in an inclination direction.

In some implementations, the surface is radially inclined to guide the poured liquid into the mixing container in the inclination direction, and the inclination direction of the surface is the same as a rotation direction of the stirring component.

In some implementations, at least some of the orifices are arranged in a grid array on one end surface of the pouring structure.

In some implementations, the pouring structure includes at least one limiting component, and

one end surface of the limiting component is detachable from an open side of the mixing container.

In some implementations, a through hole is provided in the limiting component, and the stirring component of the beverage making machine is extended into the mixing container through the through hole.

In some implementations, the rotation direction of the stirring component is clockwise when observed from a front part of the beverage making machine.

In some implementations, the open structure is disposed on an inner edge of an upper end of the limiting component.

In some implementations, a feeding through hole is provided in an upper end surface of the mixing container, and the open structure of the pouring structure is disposed below the feeding through hole.

In some implementations, a cover plate is disposed on an adjacent side of the feeding through hole, and the cover plate is configured to cover the feeding through hole.

In the pouring structure of a beverage making machine of the present invention, the pouring structure is set to an open structure, and a surface of the pouring structure is radially inclined relative to the central axis of the mixing container. Opposite edges of the pouring structure are set with a slope relative to the surface, and a plurality of orifices communicating with an inner cavity of the mixing container is provided on one end surface of the pouring structure. Compared with the prior art, three surfaces of a pouring mouth of the pouring structure are inclined, and the orifices are disposed along an axis. The poured fluid is drained through the inclined three surfaces, so that the poured fluid flows into the mixing container more smoothly, and a problem that a substance (such as snowflakes/shaved ice) to be mixed in the mixing container may splash or overflow to the outside by instantaneous inflow fluid impact can be resolved when the fluid is poured.

### BRIEF DESCRIPTION OF THE DRAWINGS

The present invention is further described with reference to accompanying drawings and embodiments. In the figures,

FIG. 1 is a sectional view of a beverage making machine according to an embodiment of the present invention;

FIG. 2 is an assembly diagram of a mixing container and a pouring structure according to an embodiment of the present invention;

FIG. 3 is an exploded view of the mixing container and the pouring structure according to an embodiment of the present invention;

FIG. 4 is a sectional view of the mixing container and the pouring structure according to an embodiment of the present invention;

FIG. 5 is a three-dimensional diagram of the pouring structure according to the present invention;

FIG. 6 is a three-dimensional diagram of the pouring structure according to another embodiment of the present invention; and

FIG. 7 is a sectional view of the pouring structure according to an embodiment of the present invention.

### DETAILED DESCRIPTION OF THE DRAWINGS AND THE PRESENTLY PREFERRED EMBODIMENTS

To clearly understand the technical features, purposes, and effects of the present invention, specific implementations of the present invention are described in detail with reference to the accompanying drawings.

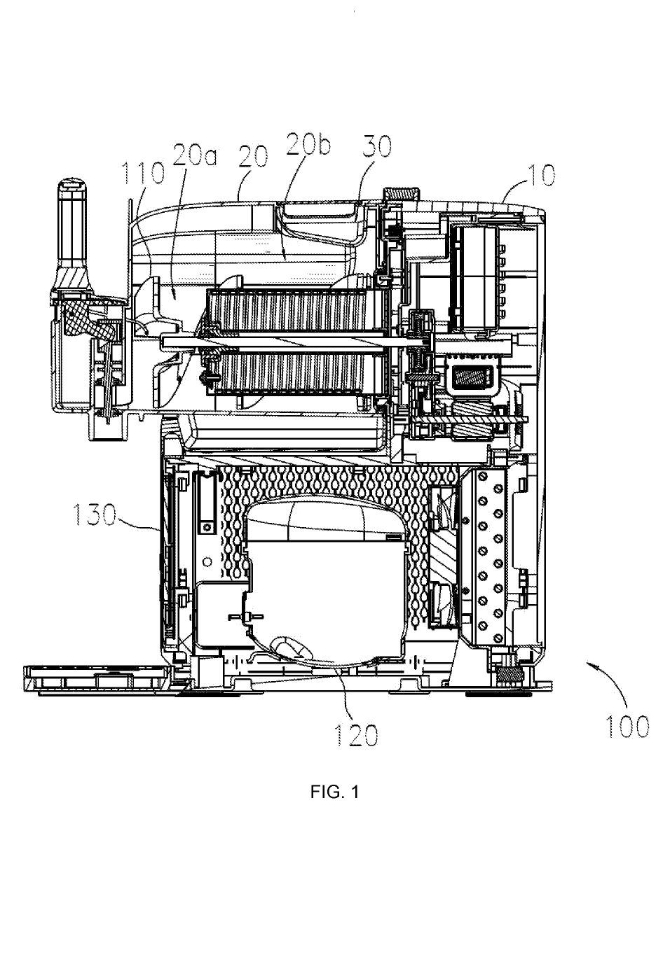

As shown in FIG. 1, in a first embodiment of a beverage making machine of the present invention, the beverage making machine 100 includes at least a housing 10, a mixing container 20, a pouring structure 30, a stirring component 110, a compressor 120, and a touchpad 130.

The housing 10 is configured to carry the mixing container 20, the stirring component 110, and the compressor 120.

The mixing container 20 is disposed at a front end of the beverage making machine 100 and is a cylinder of a hollow structure 20a for accommodating ice cubes, shaved ice, or a finished product to be mixed.

The stirring component 110 is configured inside the hollow structure 20a of the mixing container 20.

The compressor 120 compresses a refrigerant into high-temperature and high-pressure steam, which becomes liquid after cooling by the condenser. The liquid enters an evaporator through depressurization of an expansion valve and absorbs a large amount of heat to implement rapid cooling, thereby achieving the refrigeration effect.

A finished product of ice cubes or shaved ice is conveyed to the mixing container 20 by an electric motor. Fruit or beverage in the mixing container 20 is cut into small pieces by the stirring component 110 disposed in the mixing container 20 and is stirred and evenly mixed by a stirring shaft, so that cold drinks such as shaved ice, juice, or milkshakes are produced.

The pouring structure 30 is configured to carry poured fluid, and the poured fluid is drained through opposite edges 320c, so that the liquid flows into the mixing container 20 more smoothly.

The touchpad 130 is configured to implement man-machine interaction.

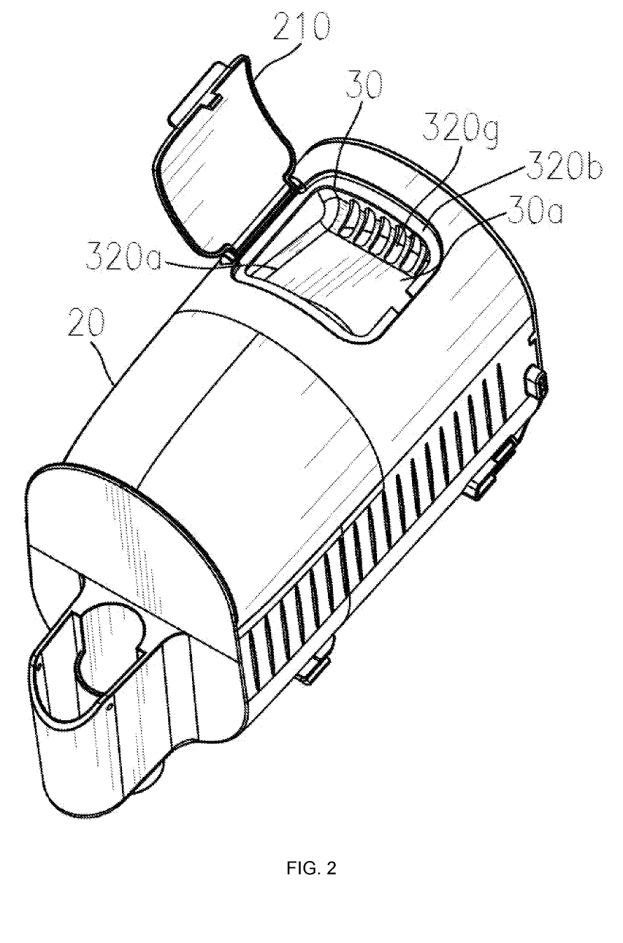

In a first embodiment of the pouring structure 30 of the present invention shown in FIG. 2, the pouring structure 30 is configured for the beverage making machine 100 and is disposed in the mixing container 20.

The pouring structure 30 is matched at an upper end of the mixing container 20 along a central axis of the mixing container 20, and can be separated from the mixing container 20.

The pouring structure 30 is set to an open structure 30a, a surface 320a of the pouring structure 30 is radially inclined relative to the central axis of the mixing container 20, and an inclination degree of the surface 320a relative to the central axis of the mixing container 20 may be within 5–15 degrees.

The opposite edges 320c of the pouring structure 30 are set with a slope relative to the surface 320a, and the slope may be set within 10–20 degrees.

The opposite edges 320c are inclined, and an edge that is of the opposite edges 320c and that is not connected to the surface 320a is inclined outward.

A plurality of orifices 320g communicating with an inner cavity (corresponding to the hollow structure 20a) of the mixing container 20 is disposed on one end surface 320b of the pouring structure 30.

At least one adjacent edge 320f connected to the opposite edge 320c is inclined, and an opening area formed through enclosure by the opposite edges 320c, the adjacent edge 320f, and a top of the end surface 320b is greater than an area of the surface 320a.

When the technical solution is used, three surfaces (corresponding to the opposite edges 320c and the adjacent edge 320f) of a pouring mouth (corresponding to the open structure 30a) of the pouring structure 30 are inclined, and the orifices 320g are disposed along an axis. The poured fluid is drained through the inclined three surfaces, so that the poured fluid flows into the mixing container 20 more smoothly, and a problem that a substance (such as snowflakes/shaved ice) to be mixed in the mixing container 20 may splash or overflow to the outside by instantaneous inflow fluid impact can be resolved when the fluid is poured.

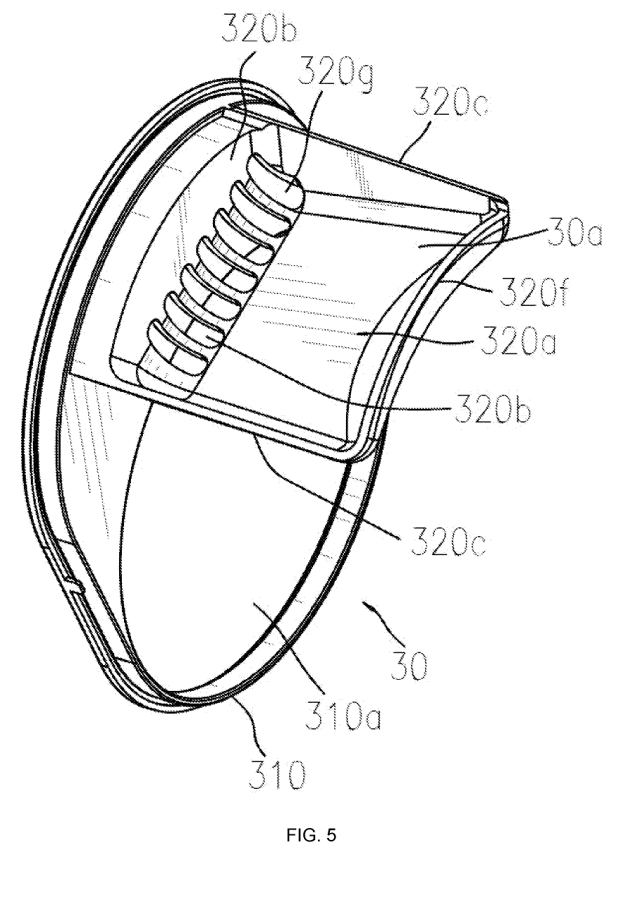

In some implementations, as shown in FIG. 5, to improve the drainage effect of the liquid, the opposite edges 320c and the adjacent edge 320f of the opposite edges 320c may be radially inclined, and the end surface 320b opposite to the adjacent edge 320f may also be radially inclined. The opposite edges 320c, the adjacent edge 320f, and the end surface 320b are inclined along a direction of the surface 320a, so that the poured fluid flows in a direction of the surface 320a, to guide the poured fluid into the mixing container 20 in an inclination direction.

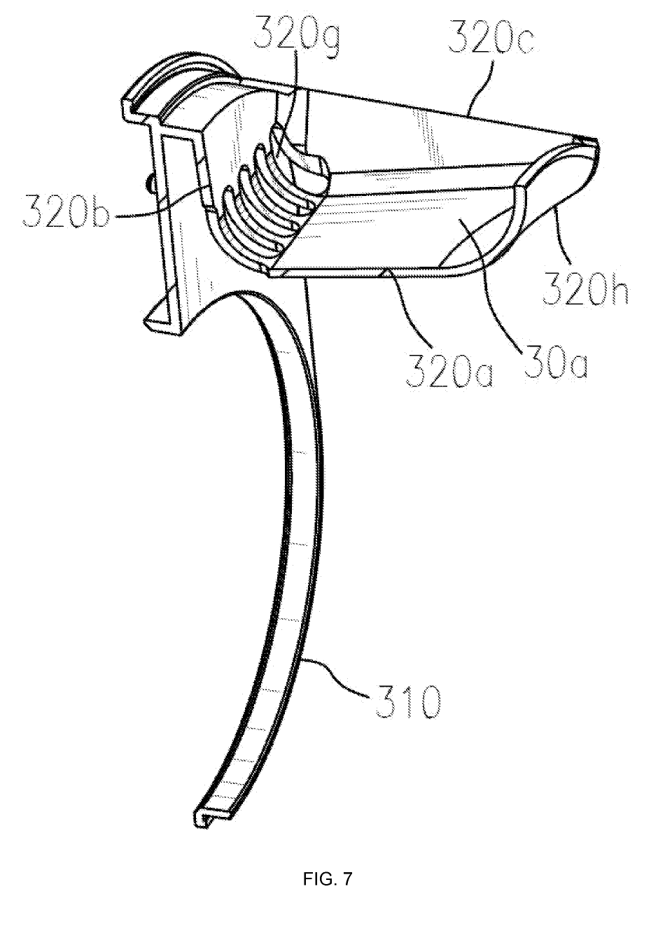

In some implementations, as shown in FIG. 7, to improve the drainage effect of the liquid, the surface 320a can be radially inclined relative to the central axis of the mixing container 20, and an inclination angle of the surface 320a relative to the mixing container 20 is gradually narrowed along a direction of the orifices 320g, to guide the poured fluid into the mixing container 20 in the inclination direction.

The inclination direction of the surface 320a is the same as a rotation direction of the stirring component 110, so that an impact force for flowing into the fluid is absorbed by the stirring component 110 during rotation.

In some implementations, as shown in FIG. 5 and FIG. 7, to improve a speed at which the fluid enters the mixing container 20, at least some of the orifices 320g can be arranged in a grid array on one end surface 320b of the pouring structure 30, and all orifices 320g are arranged at intervals and extend upwards along the end surface 320b to increase orifice sizes.

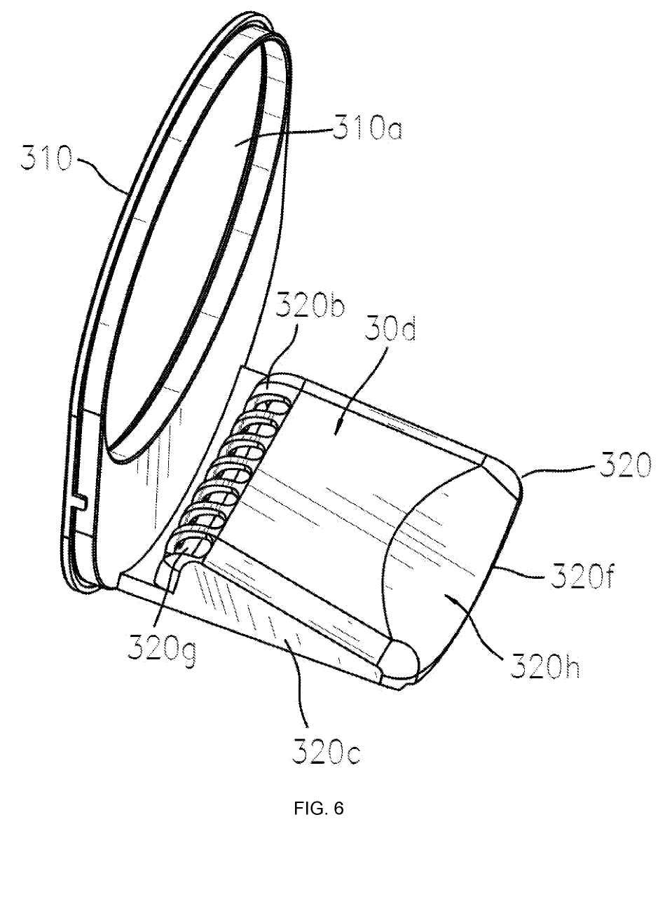

As shown in FIG. 6, an opposite surface (corresponding to the adjacent edge 320f) of the orifices 320g is set to an invaginated arc 320h.

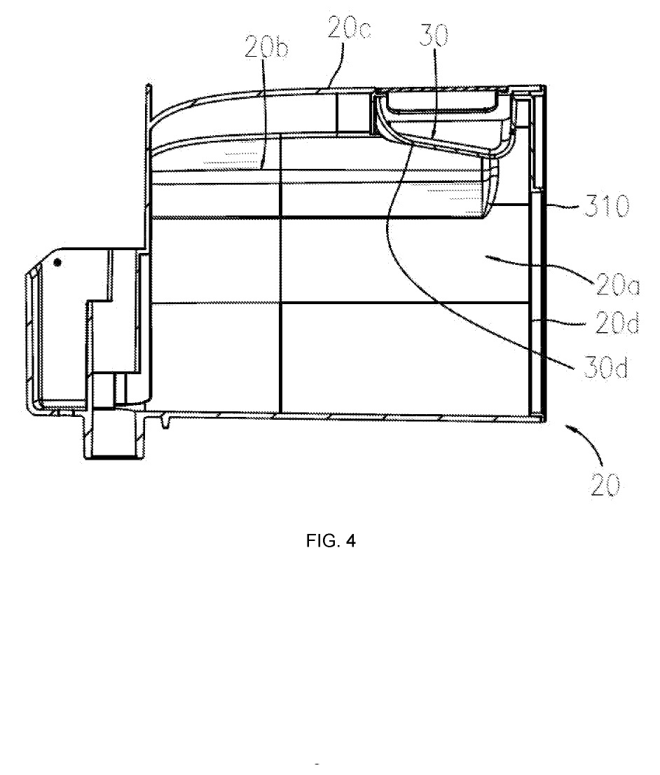

In some implementations, as shown in FIG. 4 and FIG. 6, to improve the flexibility of assembling the pouring structure 30 with the mixing container 20, at least one limiting component 310 can be arranged on the pouring structure 30. When the limiting component 310 is circular, and the pouring structure 30 is disposed in the mixing container 20, one end surface of the limiting component 310 can be disposed within an open side 20d of the mixing container 20 and can be detached from the mixing container 20.

In some implementations, as shown in FIG. 5 and FIG. 6, a through hole 310a is provided in the limiting component 310, and the stirring component 110 of the beverage making machine can be extended into the hollow structure 20a of the mixing container 20 through the through hole 310a.

In some implementations, as shown in FIG. 1, a rotation direction of the stirring component 110 is clockwise when observed from a front part (corresponding to the touchpad 130) of the beverage making machine 100.

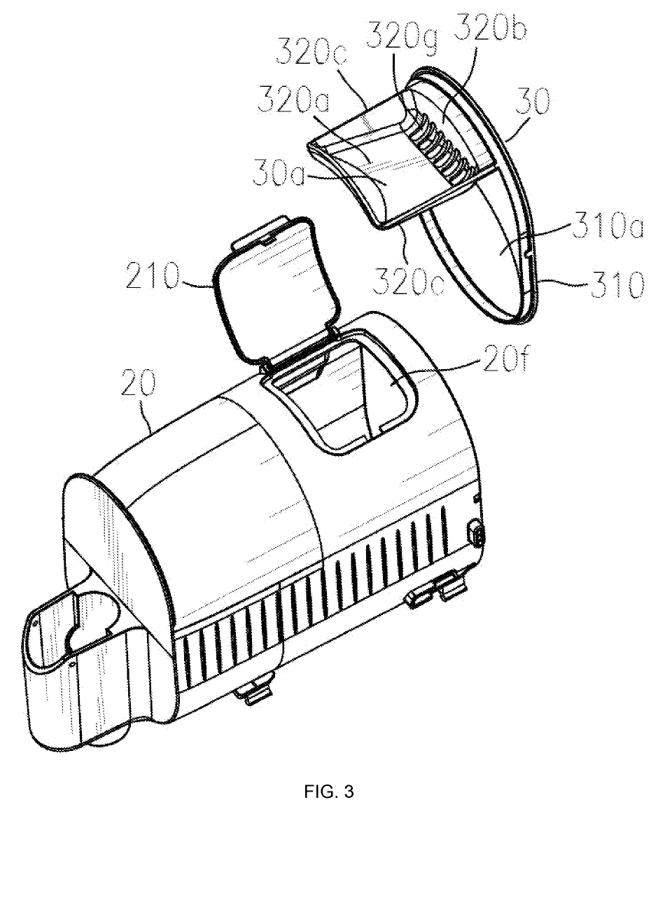

In some implementations, as shown in FIG. 3, the open structure 30a is disposed on an inner edge of an upper end of the limiting component 310.

In some implementations, as shown in FIG. 3 and FIG. 4, a feeding through hole 20f is provided in an upper end surface 20c of the mixing container 20, and the open structure 30a of the pouring structure 30 is disposed below the feeding through hole 20f.

In some implementations, as shown in FIG. 3, a cover plate 210 is disposed on an adjacent side of the feeding through hole 20f, and the cover plate 210 is configured to cover the feeding through hole 20f.

In some implementations, as shown in FIG. 1, at least one inwardly protruding turbulence component 20b is disposed on an inner wall of the mixing container 20, and the turbulence component 20b can be relatively disposed at an upper end of the mixing container 20 and can be higher than the stirring component 110.

As shown in FIG. 4 and FIG. 6, a lower end surface 30d of the pouring structure 30 protrudes along the inner cavity of the mixing container 20, that is, the turbulence component 20b can cooperate with the lower end surface 30d. When the stirring component 110 stirs the substance to be mixed in the mixing container 20, the substance to be mixed flows in the rotation direction of the stirring component 110. When the substance to be mixed is directed towards the turbulence component 20b and the lower end surface 30d by the stirring component 110, some of the substance to be mixed is blocked by the turbulence component 20b and the lower end surface 30d, and the substance to be mixed falls off due to own weight, which can reduce adsorption of the substance to be mixed on a surface of the hollow structure 20a of the mixing container 20 and improve the fluidity of the substance to be mixed inside the mixing container 20.

The embodiments of the present invention are described above with reference to the accompanying drawings, but the present invention is not limited to the foregoing specific implementations, and the foregoing specific implementations are only illustrative and not restrictive. Under the enlightenment of the present invention, persons of ordinary skill in the art can make many forms without departing from the purpose of the present invention and the protection scope of the claims, all of which fall within the protection of the present invention.

1. A pouring structure of a beverage making machine, configured for the beverage making machine, wherein
the pouring structure is configured in a mixing container and matched at an upper end of the mixing container along a central axis of the mixing container,
the pouring structure is set to an open structure, and a surface of the pouring structure is radially inclined relative to the central axis of the mixing container;
opposite edges of the pouring structure are set with a slope relative to the surface,
and a plurality of orifices communicating with an inner cavity of the mixing container is disposed on one end surface of the pouring structure.

2. The pouring structure of a beverage making machine according to claim 1, wherein
the opposite edges are radially inclined to guide poured liquid into the mixing container in an inclination direction.

3. The pouring structure of a beverage making machine according to claim 2, wherein
the surface is radially inclined to guide the poured liquid into the mixing container in the inclination direction, and the inclination direction of the surface is the same as a rotation direction of the stirring component.

4. The pouring structure of a beverage making machine according to claim 3, wherein
at least some of the orifices are arranged in a grid array on one end surface of the pouring structure.

5. The pouring structure of a beverage making machine according to claim 4, wherein
the pouring structure comprises at least one limiting component, and
one end surface of the limiting component is detachable from an open side of the mixing container.

6. The pouring structure of a beverage making machine according to claim 5, wherein
a through hole is provided in the limiting component, and the stirring component of the beverage making machine is extended into the mixing container through the through hole.

7. The pouring structure of a beverage making machine according to claim 6, wherein
the rotation direction of the stirring component is clockwise when observed from a front part of the beverage making machine.

8. The pouring structure of a beverage making machine according to claim 7, wherein
the open structure is disposed on an inner edge of an upper end of the limiting component.

9. The pouring structure of a beverage making machine according to claim 8, wherein
a feeding through hole is provided in an upper end surface of the mixing container, and the open structure of the pouring structure is disposed below the feeding through hole.

10. The pouring structure of a beverage making machine according to claim 9, wherein
a cover plate is disposed on an adjacent side of the feeding through hole, and the cover plate is configured to cover the feeding through hole.
